(19) United States
(12) Patent Application Publication
(10) Pub. No.: US 2024/0348059 A1
(43) Pub. Date: Oct. 17, 2024

(54) CONFIGURABLE PORTABLE SOLOR POWER GENERATION AND DISTRIBUTION SYSTEM AND METHOD

(71) Applicant: BHUGESH INVESTMENTS, LLC, d/b/a BI PRODUCTION WORKS, Madison, GA (US)

(72) Inventors: Stephen Marc FREDERICK, Rutledge, GA (US); Philip DEVLIN, Madison, GA (US); Phillip Henry SLOANE, Madison, GA (US)

(21) Appl. No.: 18/615,411

(22) Filed: Mar. 25, 2024

Related U.S. Application Data
(60) Provisional application No. 63/495,662, filed on Apr. 12, 2023.

(51) Int. Cl. H02J 3/46; B60L 53/51; H02J 3/32; H02J 7/35; H02S 40/36

(52) U.S. Cl. CPC H02J 3/46; B60L 53/51; H02J 3/32; H02J 7/35; H02S 40/36; H02J 2300/24

(57) ABSTRACT

Technologies for zero-emission power generation include a system with a power station unit coupled to multiple production units by an alternating current connection and a direct current connection. Each production unit may be a trailer for film and television production, an over-the-road trailer, or other portable unit. Each production unit includes a power generation system such as a photovoltaic solar power system. The power station unit causes power generated at the production units to flow to the power station unit via the direct current connections, and delivers the generated power to the production units via the alternating current connections. The generated power may be stored by the production units or used to power external loads or internal loads at the production units. Stored energy from the production units may flow to the power station unit via the direct current connections. Other embodiments are described and claimed.

### CROSS-REFERENCE TO RELATED APPLICATION

This application claims priority under 35 U.S.C. § 119 (e) to U.S. Provisional Application Ser. No. 63/495,662, filed Apr. 12, 2023, the entire disclosure of which is hereby incorporated by reference.

### FIELD OF THE INVENTION

The present disclosure relates, in exemplary embodiments, to electrical power generation and distribution systems and methods of power distribution.

### BACKGROUND

Film and television production typically requires a relatively large amount of electrical power. For example, a film site may require 120 kilowatts/1200 amperes of electrical power. However, many film and television production sites are located without access to grid power or otherwise require power autonomy. Many film and television productions use a diesel generator or similar solution to provide electrical power that also produces carbon emissions.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to the more detailed description below.

Generally described, the present disclosure provides in a first exemplary embodiment a system for zero-emission power generation, comprising a power station unit and a plurality of production units. The power station unit comprises a power controller and an alternating current power distribution system. Each production unit of the plurality of production units comprises a zero-emission power generation system and an energy storage system. The power station unit is coupled to each of the plurality of production units via a direct current connection and an alternating current connection. The power controller of the power station unit is configured to configure a power distribution element of a first production unit of the plurality of production units to cause power generated by the power generation system of the first production unit to flow to the power station unit via the direct current connection, and to configure the alternating current power distribution system of the power station unit to deliver the power generated by the power generation system of the first production unit to the plurality of production units via the alternating current connection.

In some embodiments, the power generation system of each production unit comprises a photovoltaic solar power generation system. In some embodiments, each production unit comprises a string of photovoltaic panels configurably coupled to the direct current connection and the energy storage system. In some embodiments, the plurality of production units provide 60 kW total power from the photovoltaic solar power generation systems. In some embodiments, the plurality of production units provide 120 kW total power from the photovoltaic solar power generation systems.

In some embodiments, the power distribution element comprises a controllable bypass switch coupled to the power generation system. In some embodiments, the power controller of the power station unit is further to configure the first production unit to store the power received via the alternating current connection with the energy storage system. In some embodiments, the power controller of the power station unit is further to configure the first production unit to output stored power from the energy storage system to the power station unit via the direct current connection.

In some embodiments, the power controller of the power station unit is further to configure the alternating current power distribution system of the power station unit to deliver the power generated by the power generation system of the first production unit to an external load via the alternating current connection. In some embodiments, the external load comprises an electric vehicle charging station. In some embodiments, the system further comprises an external load or an internal load coupled to a production unit, the production unit to deliver the power generated by the power generation system of the first production unit to the internal load or the external load.

In some embodiments, each production unit comprises a portability feature. In some embodiments, each production unit comprises a trailer having a plurality of wheels, a towing attachment, and a roof-mounted solar panel. In some embodiments, each production unit trailer comprises an occupiable space. In some embodiments, production unit comprises an over the road vehicle. In some embodiments, each production unit comprises a shipping container.

The present disclosure also provides in another exemplary embodiment a method for zero-emission power generation, comprising connecting a power station unit to a plurality of production units, wherein each production unit comprises a zero-emission power generation system, and wherein the power station unit is coupled to each production unit via a direct current connection and an alternating current connection; configuring, by a power controller of the power station unit, a power distribution element of a first production unit of the plurality of production units to cause power generated by the power generation system of the first production unit to flow to the power station unit via the direct current connection; and configuring, by the power controller of the power station unit, an alternating current power distribution system of the power station unit to deliver the power generated by the power generation system of the first production unit to the plurality of production units via the alternating current connection. In some embodiments, the power generation system of each production unit comprises a photovoltaic solar power generation system.

In some embodiments, the power distribution element comprises a controllable bypass switch coupled to the power generation system. In some embodiments, each production unit comprises an energy storage system, the method further comprising configuring, by the power controller of the power station unit, the first production unit to store the power received via the alternating current connection with the energy storage system. In some embodiments, the method further comprises configuring, by the power control of the power station unit, the first production unit to output stored power from the energy storage system to the power station unit via the direct current connection.

In some embodiments, the method further comprises configuring, by the power controller of the power station unit, the alternating current power distribution system of the power station unit to deliver the power generated by the power generation system of the first production unit to an external load via the alternating current connection. In some embodiments, the method further comprises delivering the power generated by the power generation system of the first production unit to an external load or an internal load coupled to a production unit.

The present disclosure also provides in another exemplary embodiment one or more non-transitory, computer-readable media comprising a plurality of instructions that, in response to being executed, cause a power controller to configure a power distribution element of a first production unit of a plurality of production units to cause power generated by a zero-emission power generation system of the first production unit to flow to a power station unit via a direct current connection; and configure an alternating current power distribution system of the power station unit to deliver the power generated by the power generation system of the first production unit to the plurality of production units via an alternating current connection, wherein the power station unit is coupled to each production unit via a direct current connection and an alternating current connection. In some embodiments, the power generation system of each production unit comprises a photovoltaic solar power generation system.

In some embodiments, the power distribution element comprises a controllable bypass switch coupled to the power generation system. In some embodiments, each production unit comprises an energy storage system, and the one or more non-transitory, computer-readable media further comprise a plurality of instructions that, in response to being executed, cause the power controller to configure the first production unit to store the power received via the alternating current connection with the energy storage system. In some embodiments, the one or more non-transitory, computer-readable media further comprise a plurality of instructions that, in response to being executed, cause the power controller to configure the first production unit to output stored power from the energy storage system to the power station unit via the direct current connection. In some embodiments, the one or more non-transitory, computer-readable media further comprise a plurality of instructions that, in response to being executed, cause the power controller to configure the first production unit to output stored power from the energy storage system to the power station unit via the direct current connection.

In some embodiments, the one or more non-transitory, computer-readable media further comprise a plurality of instructions that, in response to being executed, cause the power controller to configure the alternating current power distribution system of the power station unit to deliver the power generated by the power generation system of the first production unit to an external load via the alternating current connection. In some embodiments, the power generated by the power generation system of the first production unit is to be delivered to an external load or an internal load coupled to a production unit.

Other features will become apparent upon reading the following detailed description of certain exemplary embodiments, when taken in conjunction with the appended claims.

### BRIEF DESCRIPTION OF THE DRAWINGS

The drawings disclose exemplary embodiments in which like reference characters designate the same or similar parts throughout the figures of which:

FIG. 1 is a simplified block diagram of one exemplary embodiment of the present disclosure.

FIG. 2 is a simplified flow diagram of at least one embodiment of a method for configurable and portable solar power generation.

FIG. 3 is a schematic diagram illustrating one exemplary embodiment of the system of FIGS. 1-2.

FIG. 4 is a schematic diagram illustrating one exemplary configuration of power flow for the system of FIG. 3.

FIG. 5 is a schematic diagram illustrating another exemplary configuration of power flow for the system of FIG. 3.

FIG. 6 is a schematic diagram illustrating yet another exemplary configuration of power flow for the system of FIG. 3.

FIG. 7 is a simplified block diagram of one exemplary embodiment of the system of FIGS. 1-2.

FIG. 8 is a simplified block diagram of one exemplary embodiment of a power station unit of FIGS. 1-2.

FIG. 9 is a simplified block diagram of one exemplary embodiment of a production unit of FIGS. 1-2.

FIG. 10 is a simplified block diagram of another exemplary embodiment of a production unit of FIGS. 1-2.

### DETAILED DESCRIPTION

Unless otherwise indicated, the drawings are intended to be read (for example, cross-hatching, arrangement of parts, proportion, degree, or the like) together with the specification, and are to be considered a portion of the entire written description of this invention. As used in the following description, the terms “horizontal”, “vertical”, “left”, “right”, “up” and “down”, “upper” and “lower” as well as adjectival and adverbial derivatives thereof (for example, “horizontally”, “upwardly”, or the like), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

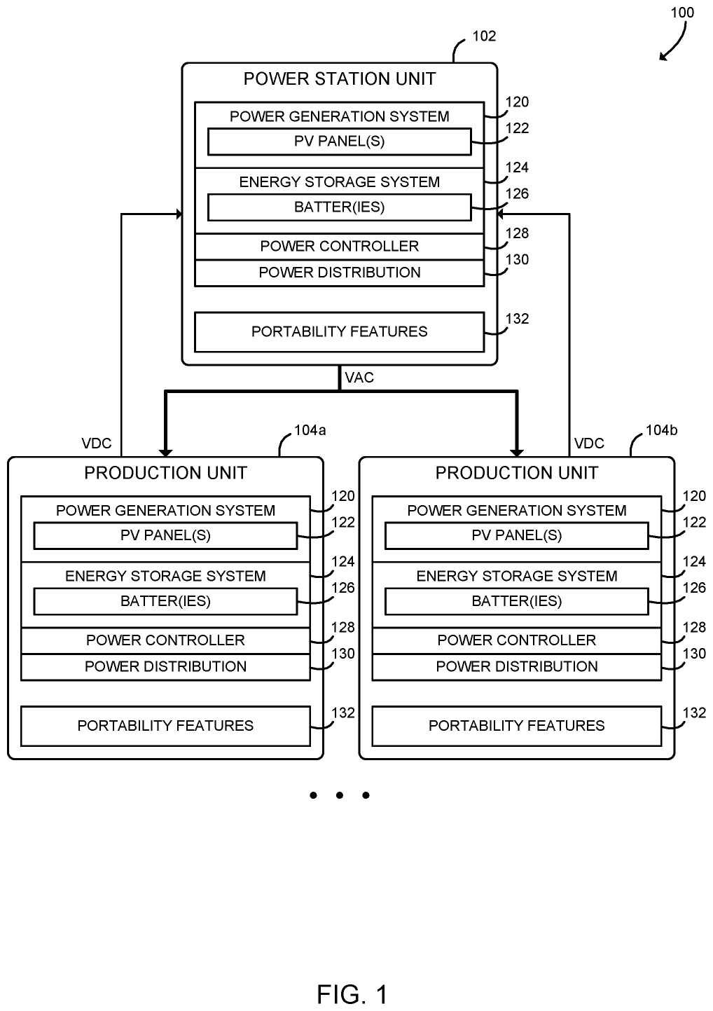

Referring now to FIG. 1, an illustrative system 100 for configurable, portable solar power generation includes one or more power station units 102 coupled to multiple production units 104. In use, as described further below, photovoltaic (PV) panels on each production unit 104 generate electrical power which is transmitted to the power station unit 102 via one or more direct current (DC) cable connections. The power station unit 102 then distributes this power to the production units 104 and/or external loads via one or more alternating current (AC) cable connections. The power station unit 102 may manage energy storage and delivery for all of the production units 104. Accordingly, the system 100 may provide zero-emission electrical power in sufficient amounts for numerous applications, such as a film or television production, vehicle recharging, or other applications. For example, the system 100 may be capable of providing 120 KW of zero-emissions solar power, which is equivalent to diesel generation traditionally used in film and television production. Further, the system 100 may provide aggregated power generated by multiple production units 104, and is thus capable of delivering more power than traditional systems that were limited to a single PV installation. The system 100, including the power station unit 102 and the production units 104, is portable and may be set up at different locations. Further, the system 100 is capable of generating sufficient electrical power using, for example, roof-mounted solar panels attached to the power station unit 102 and the production units 104. Accordingly, the system 100 is capable of generating electrical power with a reduced physical footprint compared to, for example, solar farms, standalone solar panels, or other dedicated solar power generation systems.

The power station unit 102 may be embodied as a trailer or other portable device capable of performing the functions described herein. For example, the power station unit 102 may be embodied as a 24-foot trailer that does not include occupiable space. As shown in FIG. 1, the power station unit 102 includes a power generation system 120 including one or more PV panels 122, an energy storage system 124 including one or more batteries 126, a power controller 128, a power distribution system 130, and one or more portability features 132. The illustrative power generation system 120 includes capacity for 10 KW of solar power production. For example, the power station unit 102 may include a canopy of PV panels 122 arranged on a roof of the power station unit 102 and/or a deployable canopy of PV panels 122. Although illustrated as including photovoltaic panels, it should be understood that in other embodiments the power generation system may include any other zero-emission power generation sources, such as thermal solar, wind, hydroelectric, or other generation sources.

The illustrative energy storage system 124 includes capacity for 360 kWh of energy storage. For example, the power generation system may include an array of three lithium-ion battery packs each including 120 kWh of energy storage capacity. Similarly, although illustrated as including lithium-ion batteries, it should be understood that in other embodiments the energy storage system 124 may include any other energy storage technology, such as alternative battery chemistries, supercapacitors, flywheel storage, or other energy storage devices.

The power controller 128 may include one or more inverters, rectifiers, voltage converters, and/or other electrical power management components. The power controller 128 is configured to manage charging and discharging of the batteries 126 of the energy storage system 124, and is further configured to manage generation of AC power from the power generation system 120 and/or the energy storage system 124. Accordingly, in some embodiments, the power controller 128 may include one or more processing elements, such as a microcontroller, digital signal processor, single- or multi-core processor, or other processor or processing/controlling circuit. The power distribution system 130 includes one or more load panels, combiner panels, switches, circuit breaker panels, and other electrical power distribution equipment. The power distribution system 130 may include AC power distribution equipment and DC power distribution equipment.

The portability features 132 may include wheels, towing attachments, or other features that may usable in moving the power station unit 102 from one location to another location. In some embodiments, the power station unit 102 may be approved or otherwise designed for over-the-road transportation. For example, in an embodiment, the power station unit 102 may be embodied as a trailer that may be towed by a tractor, truck, or other vehicle. As another example, in some embodiments the power station unit 102 may embodied as a standard shipping container that may be transported using intermodal transport. In some embodiments, the power station unit 102 may be embodied as a vehicle or other self-propelled device, such as a truck, van, bus, or other vehicle. Additionally or alternatively, although illustrated as including portability features 132, in some embodiments, the power station unit 102 may be stationary.

Each production unit 104 may be embodied as a trailer such as a cast trailer, office trailer, hair and makeup trailer, wardrobe trailer, honey wagon trailer, camera truck, grip trailer, electrical trailer, or any other powered production unit that can be connected to a power station unit 102. As shown, each production unit 104 also includes a power generation system 120 including one or more PV panels 122, an energy storage system 124 including one or more batteries 126, a power controller 128, a power distribution system 130, and one or more portability features 132. In an embodiment, illustrative power generation system 120 includes capacity for 5 kW of solar power production, and the illustrative energy storage system 124 includes capacity for 40 kWh of energy storage. In another embodiment, illustrative power generation system 120 includes capacity for 7.5 kW of solar power production, and the illustrative energy storage system 124 includes capacity for 80 kWh of energy storage.

As shown, the power station unit 102 is coupled to the production units 104 by AC cabling and DC cabling. Illustratively, VAC cabling out from the power station unit 102 may include four individual 4/0 gauge high voltage shielded wires at 50 feet lengths that are connected to distribution boxes for runs out to 300 feet. Connections on either end of the cabling may use cam lock terminals or other connecterized couplings. Illustratively, VDC cabling into the power station unit 102 from each production unit 104 includes two combined 10 AWG shielded wires at 50 foot lengths connected to couplers for runs out to 300 feet. Waterproof connectors (e.g., LP-20 connectors) may be used to connect each production unit 104 to the power station 102.

The system 100 may include inline resettable fuses on each production unit 104 in order to stop VDC power from leaving the production unit 104 if overcurrent or short conditions occur. The power station unit 102 may also include built in monitoring and control systems to stop power import from the production units 104 if overcurrent or short conditions occur.

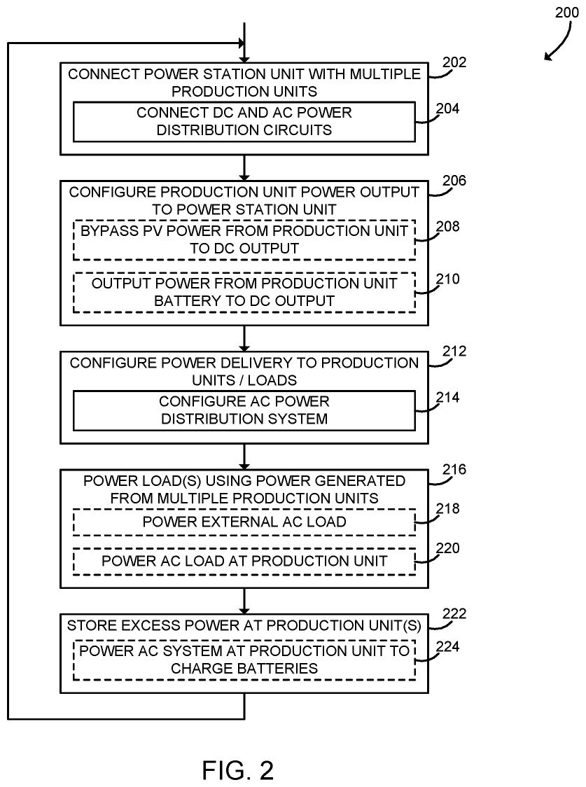

Referring now to FIG. 2, in use, the system 100 may be used with a method 200 for portable, configurable solar power generation. The method 200 begins in block 202, in which the power station unit 102 is connected with multiple production units 104. In block 204, both DC and AC power distribution circuits are connected between the power station unit 102 and the production units 104. Prior to being connected to the power station unit 102, each production unit 104 may be self-sufficient for power production and consumption. For example, power generated by the PV panels 122 of each production unit 104 may be used to charge the batteries 126 of that particular production unit 104. When the production units 104 are not connected to the power station unit 102, excess power produced by the PV panels 122 of each production unit 104 may not be used. As described further below, after being connected to the power station unit 102, the system 100 may control aggregate power generation of all the production units 104.

The particular number, type, and other configuration of the power station unit 102 and the production units 104 may depend on the particular application of the system 100. For example, for a film and television production application, the system 100 may include a power station unit 102 coupled to 10 production units 104 such as production trailers. As another example, in an embodiment the power station unit 102 may be connected to up to 22 production units 104.

As another illustrative embodiment of the present invention which may be used in a transportation application, the system 100 may include a power station unit 102 that may be coupled to a variable number of production units 104 that are tractor-trailers, trailers, or other over-the-road transportation equipment. In this embodiment, the power station 102 may be coupled to an ad hoc arrangement of production units 104 based on availability and/or location of particular production units 104.

After connecting the power station unit 102 and the production units 104, in block 206 the power station unit 102 configures power output from each production unit 104 to the power station unit 102. For example, the power controller 128 or other control element of the power station unit 102 may configure one or more bypass switches or other power distribution elements of the production unit 104 in order to control power output of the production unit 104. In some embodiments, in block 208 the power station unit 102 may bypass PV panel 122 power generation from each production unit 104 to DC output from the production unit 104 to the power station unit 102. In some embodiments, in block 210, the power station unit 102 may configure output power from the battery 126 of each production unit 104 to the DC output from the production unit 104 to the power station unit 102.

In block 212, the power station unit 102 configures power delivery to the production units 104 and/or to one or more external loads connected to the power station unit 102. In block 214, the power station unit 102 configures the AC power distribution system. Accordingly, power that is input to the power station unit 102 from the production units 104 via the DC power system may be output from the power station unit 102 to the production units 104 via the AC power system.

In block 216, the system 100 powers one or more loads using power generated by multiple production units 104. For example, solar power generated by multiple production units 104 may be transferred to the power station unit 102 via the DC power system. As another example, stored battery power provided by multiple production units 104 may be transferred to the power station 102 via the DC power system. In some embodiments, in block 218, the system 100 may power an external AC load. For example, the system 100 may output AC power from the power generation system 102 via an AC load panel or other AC connection. In some embodiments, in block 220 the system 100 may power an AC load at one or more production units 104. The AC load may include operations of the production unit 104 and/or an external load coupled to the production unit 104.

In block 222, the system 100 stores excess power at one or more production units 104. In some embodiments, in block 224 the system 100 distributes power, for example received as DC power from the production units 104 (e.g., generated solar power and/or stored battery power), through the AC power distribution system to the production units 104. The production units 104 use the supplied AC power for battery charging. After powering one or more loads and/or storing excess power, the method 200 loops back to block 202, in which the system 100 may continue to distribute power between the production units 104 and the power station unit 102. In some embodiments, the configuration of the system 100 may be changed, for example by adding or removing one or more production units 104, adding or removing one or more loads, or otherwise changing the system 100.

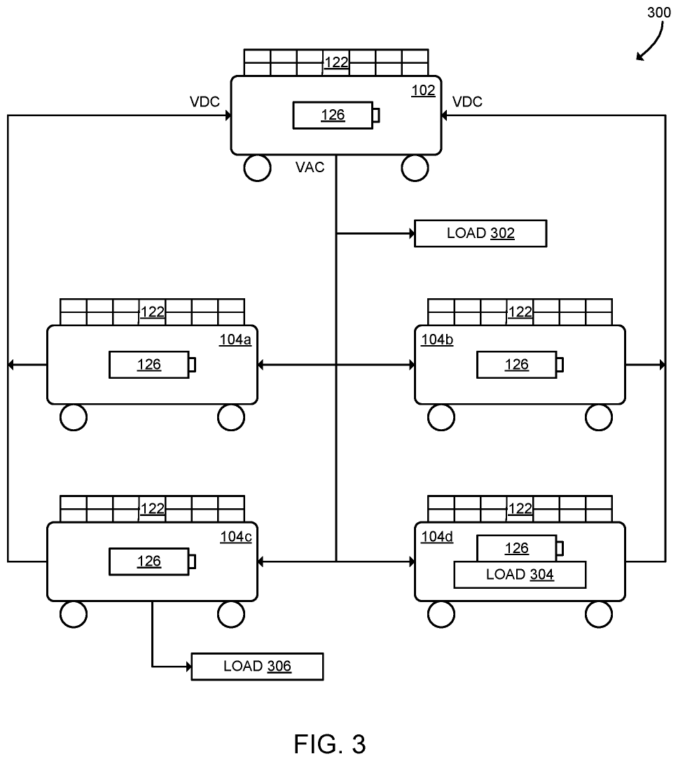

Referring now to FIG. 3, diagram 300 shows one illustrative embodiment of the system 100. As shown, the illustrative system 100 includes one power station unit 102 coupled to four production units 104a through 104d. Of course, in other embodiments, the system 100 may include a different number and/or arrangement of power station units 102 and/or production units 104. Each of the production units 104 and the power station unit 102 includes PV panels 122 for power generation and batteries 126 for energy storage. As shown, each of the production units 104 is connected to the power station unit 102 by a VDC connection (e.g., direct current). Similarly, the power station unit 102 is connected to each production unit 104 by a VAC (e.g., alternating current) connection. As described above, power may be supplied from the production units 104 to the power station unit 102 via the VDC connection, and may be supplied from the power station unit 102 to the production units 104 via the VAC connection. Power supplied via VAC may be used to power an external load 302 coupled to the power station unit 102, an internal load 304 coupled to the production unit 104d, an external load 306 coupled to the production unit 104c, and/or other internal or external loads.

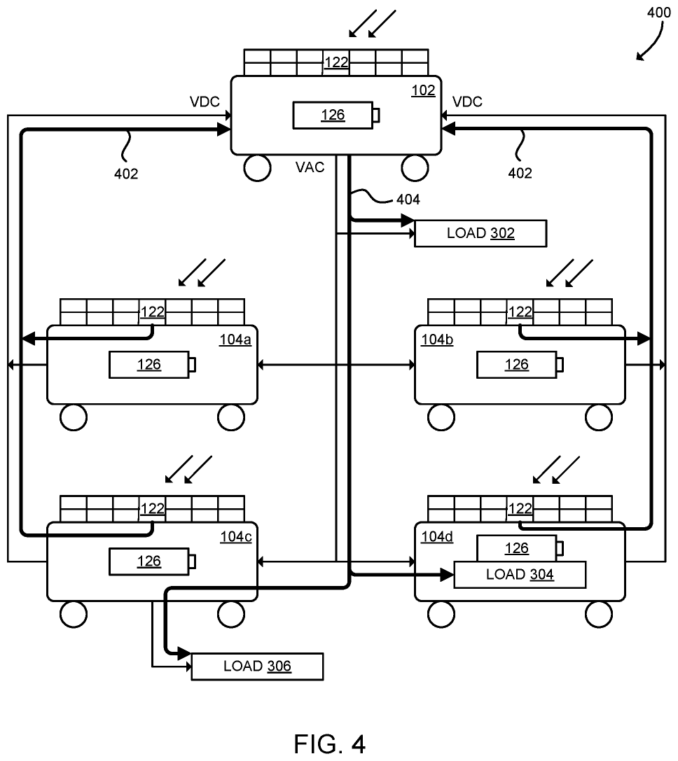

Referring now to FIG. 4, diagram 400 shows one illustrative power configuration for the system 100 shown in FIG. 3. In the illustrative configuration, the PV panels 122 are generating power from incident light (e.g., sunlight). Arrows 402 represent DC power generated by the PV panels 122 and distributed via the VDC connection from the production units 104 to the power station unit 102. The power station unit 102 may also generate DC power from its own PV panels 122. Arrows 404 represent AC power distributed from the power station unit 102 via the VAC connection to the loads 302, 304, 306. As shown, the AC power may be supplied directly to the load 302 (e.g., through an AC load panel) or to one or more of the production units 104 for delivery to the loads 304, 306.

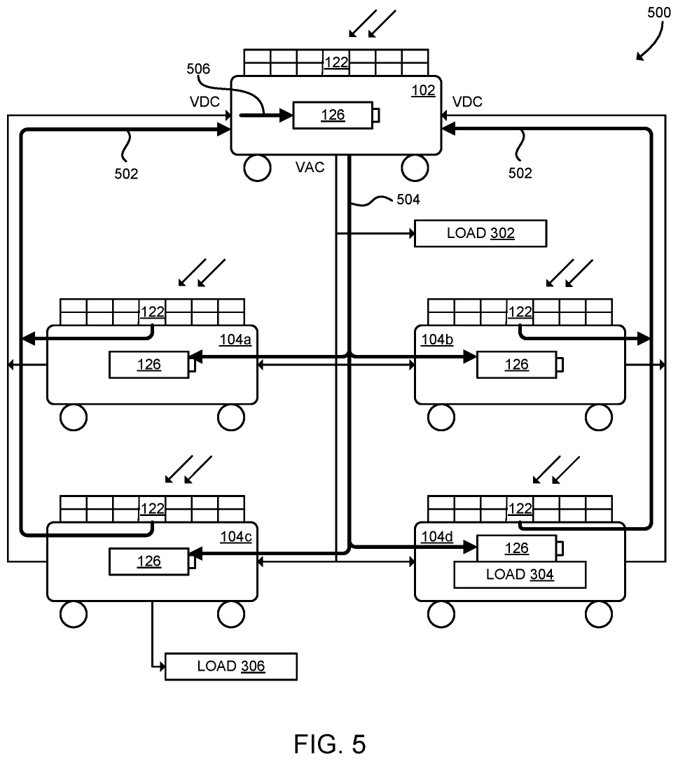

Referring now to FIG. 5, diagram 500 shows another illustrative power configuration for the system 100 shown in FIG. 3. In the illustrative configuration, the PV panels 122 are generating power from incident light (e.g., sunlight). Similar to the arrows 402 of FIG. 4, the arrows 502 represent DC power generated by the PV panels 122 and distributed via the VDC connection from the production units 104 to the power station unit 102. The power station unit 102 may also generate DC power from its own PV panels 122. Arrows 504 represent AC power distributed from the power station unit 102 via the VAC connection to the production units 104. As shown, the AC power distributed to the production units 104 is used to charge the batteries 126 of each respective production unit 104. Arrow 506 represents power used by the power station unit 102 to charge its own batteries 126. Accordingly, the configuration shown in FIG. 5 may be used to store excess power generated by the system 100 into multiple batteries 126 distributed across the system 100.

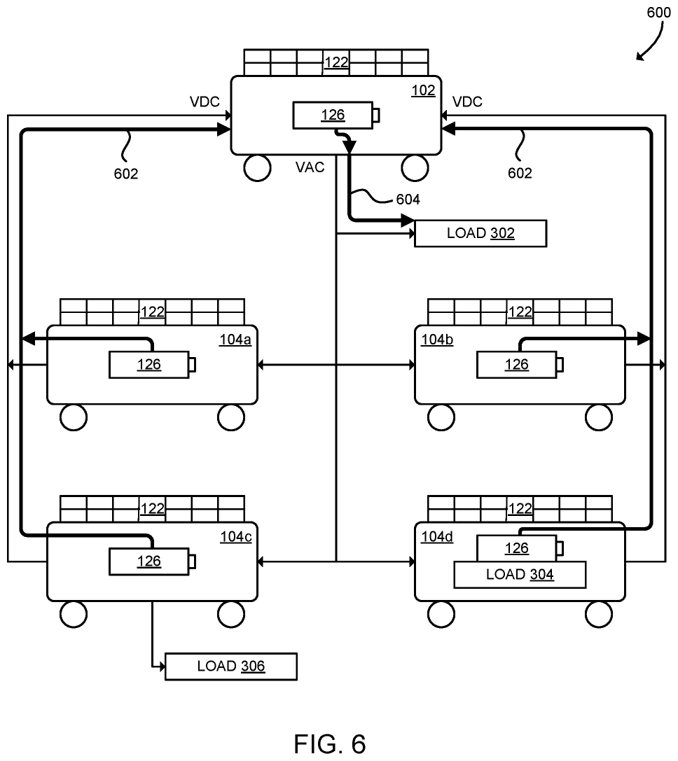

Referring now to FIG. 6, diagram 600 shows another illustrative power configuration for the system 100 shown in FIG. 3. In the illustrative configuration, the PV panels 122 are not generating power from incident light. For example, the diagram 600 may represent a configuration at night or during inclement weather. Arrows 602 represent DC power that was previously stored by the batteries 126 of each production unit 104 and distributed via the VDC connection from the respective production units 104 to the power station unit 102. The power station unit 102 may also produce DC power from its own batteries 126. Arrow 604 represents AC power distributed from the power station unit 102 via the VAC connection to the external load 302. Accordingly, the configuration shown in FIG. 6 allows stored energy that is distributed in multiple production units 104 to be supplied to a centralized external load 302. Of course, in other embodiments stored energy may similarly be supplied to the loads 304, 306 via the VAC connection (not shown).

Although numerous configurations of power flow are shown in FIGS. 4-6, it should be understood that different combinations and/or arrangements of power flow are possible. For example, in some embodiments, power generated by the production units 104 may be used to power the loads 302, 304, 306 as shown in FIG. 4 and, simultaneously, any excess power generated by the production units 104 may be used to charge the batteries 126 of the production units 104 as shown in FIG. 5.

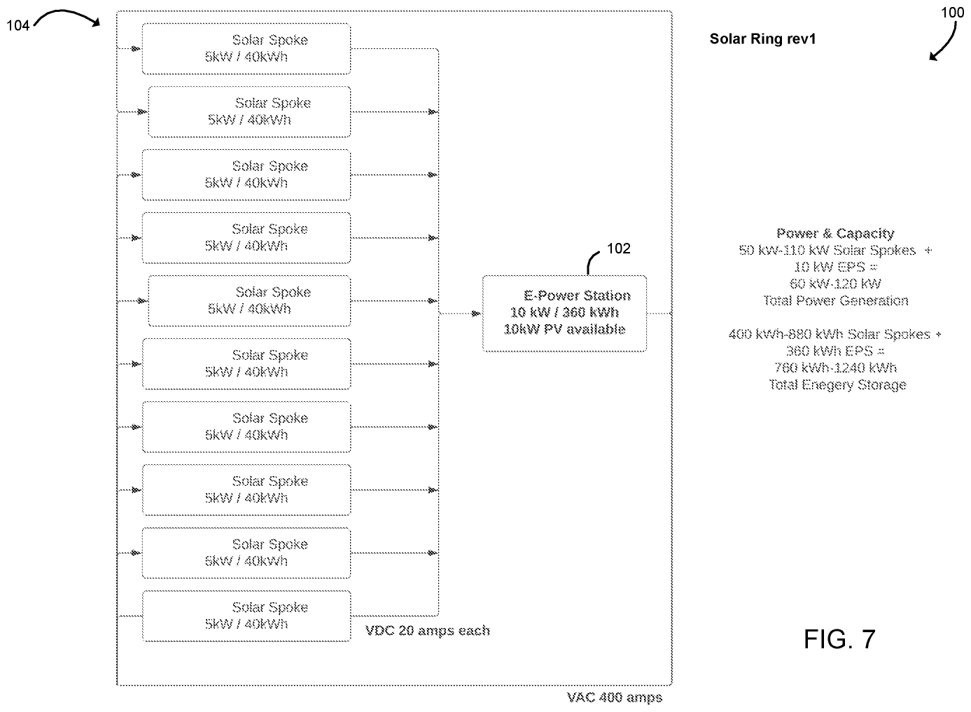

Referring now to FIG. 7, an illustrative embodiment of the system 100 is shown. The example system 100 includes a power station unit 102 labeled as an E-Power Station. The illustrative E-Power station 102 includes 10 KW of PV generation capacity and 360 k Wh of energy storage capacity. The illustrative E-Power Station 102 is coupled to ten production units 104 labeled as “Solar Spokes”. Each Solar Spoke 104 includes 5 kW of PV generation capacity and 40 kWh of energy storage capacity. As shown, each Solar Spoke 104 is coupled to the E-Power Station 102 by a 20 amp VDC connection. The E-Power Station 102 is coupled to the Solar Spokes 104 by a 400 amp VAC connection. The illustrative system 100 has total PV generation capacity of 60 KW and total energy storage capacity of 760 kWh. In other illustrative embodiments, the system 100 may include a maximum of 22 Solar Spokes 104. Accordingly, in those embodiments, the system 100 may have a maximum total PV generation capacity of 120 KW and a maximum total energy storage capacity of 1240 kWh.

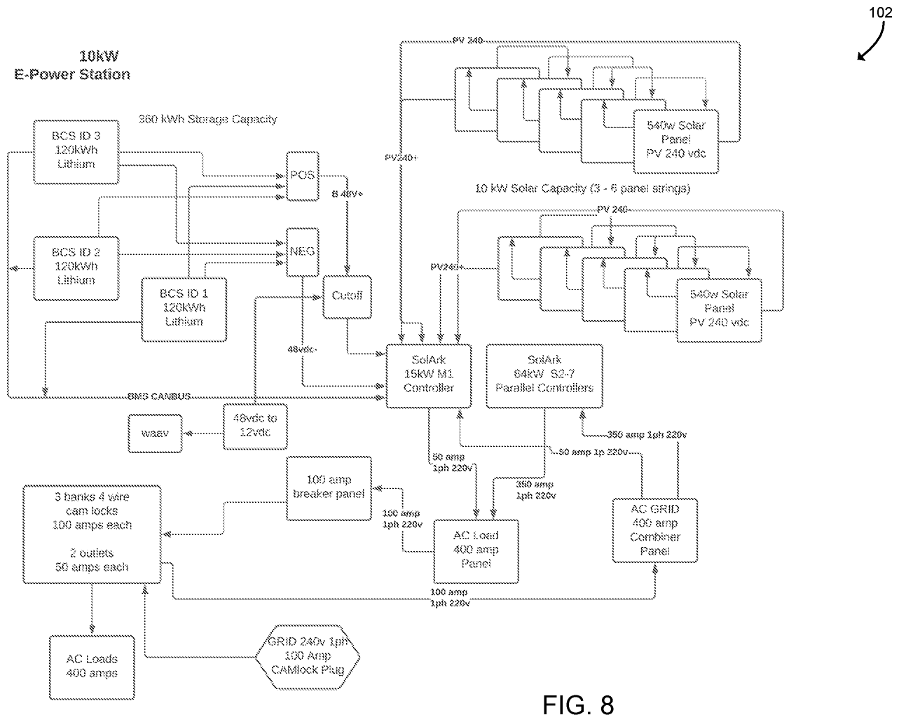

Referring now to FIG. 8, an example embodiment of the E-Power Station 102 is shown. As shown, the illustrative power generation system 120 includes three six-panel strings of 540 W solar panels generating power at 240 VDC, for a total capacity of about 10 kW. The illustrative energy storage system 124 includes three 120 kWh lithium-ion batteries for a total capacity of about 360 kWh, operating at 48 VDC. The illustrative power controller 128 includes a 15 kW solar controller/hybrid inverter/battery controller as well as a bank of 84 kW parallel controllers. The illustrative power distribution system 130 includes an AC distribution system supporting AC loads at 400 amps and a DC distribution system supporting receiving power at 20 amps VDC from the Solar Spokes 104.

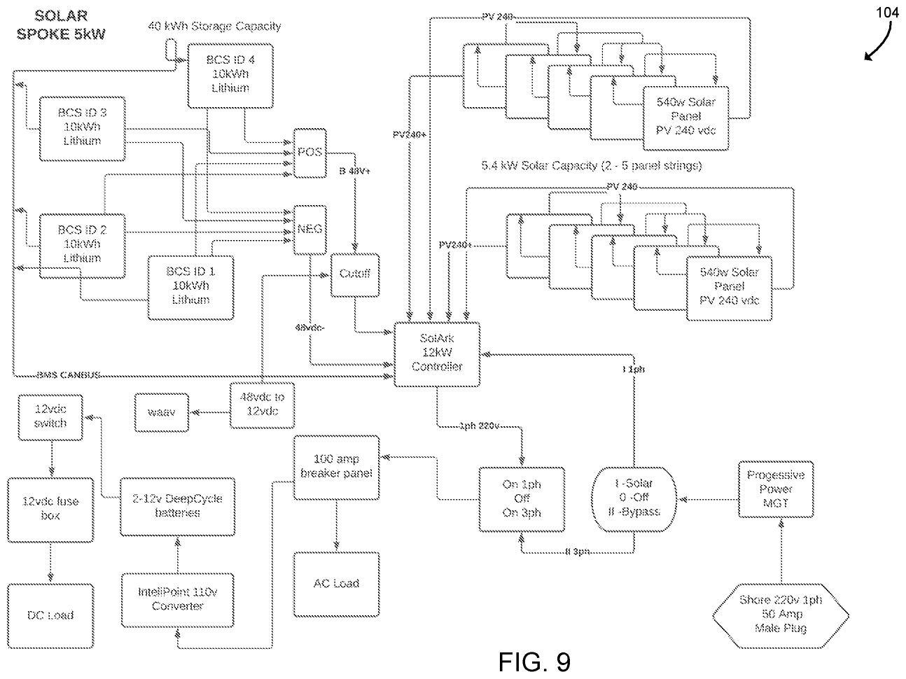

Referring now to FIG. 9, an example embodiment of the Solar Spoke 104 is shown. As shown, the illustrative power generation system 120 includes two five-panel strings of 540 W solar panels generating power at 240 VDC, for a total capacity of about 5 kW. The illustrative energy storage system 124 includes four 10 kWh lithium-ion batteries for a total capacity of about 40 kWh, operating at 48 VDC. The illustrative power controller 128 includes a 12 kW solar controller/hybrid inverter/battery controller. The illustrative power distribution system 130 includes an AC distribution system supporting AC loads at 100 amps and a DC distribution system supporting DC loads at 12 VDC. The power distribution system 130 also includes a switchable bypass system allowing VAC input received from the E-Power Station 102 to be used to charge the energy storage system 124 and/or power loads.

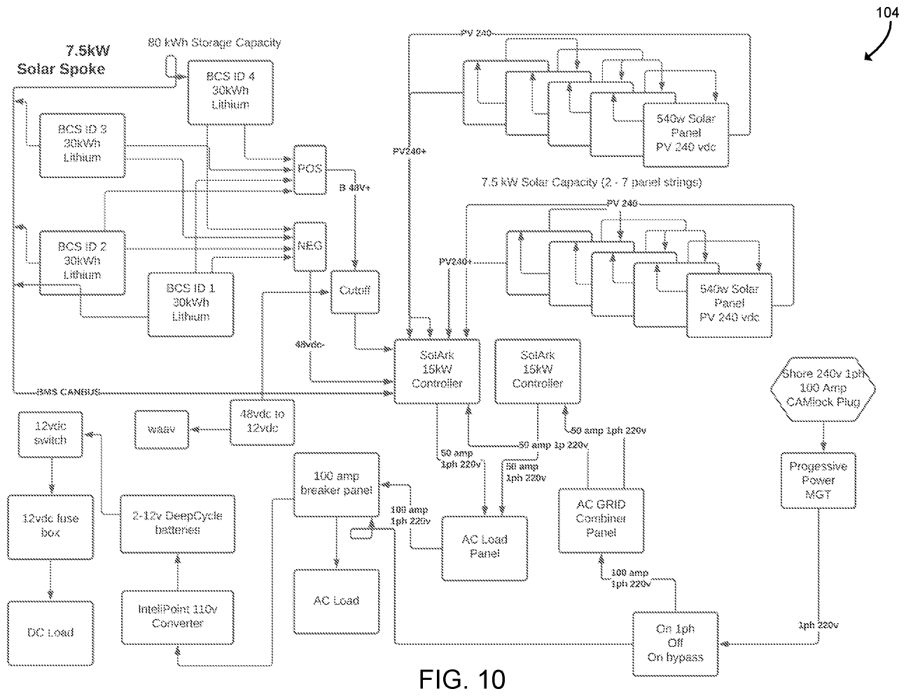

Referring now to FIG. 10, another illustrative embodiment of the Solar Spoke 104 is shown. As shown, the illustrative power generation system 120 includes two seven-panel strings of 540 W solar panels generating power at 240 VDC, for a total capacity of about 7.5 kW. The illustrative energy storage system 124 includes four 30 kWh lithium-ion batteries for a total capacity of at least 80 kWh, operating at 48 VDC. The illustrative power controller 128 includes two 15 kW solar controller/hybrid inverter/battery controllers. The illustrative power distribution system 130 includes an AC distribution system supporting AC loads at 100 amps and a DC distribution system supporting DC loads at 12 VDC. The power distribution system 130 also includes a switchable bypass system and AC grid combiner panel allowing VAC input received from the E-Power Station 102 to be used to charge the energy storage system 124 and/or power loads.

In another illustrative embodiment, the power station unit 102 may be located at a transportation hub such as a fuel station, truck stop, rest area, or other location where commercial trucks or other vehicles may stop for an extended time. In such embodiments the power station unit 102 may be fixed or portable, and may be embodied, for example, as an open or closed 53-foot trailer or other trailer for over-the-road use. Similarly, the production units 104 may be embodied as 53-foot flatbed trailers, closed trailers, vans, trucks, or other over-the-road transportation devices. In those embodiments, batteries 126 may be stored in a jockey box under the tractor/trailer, and PV panels 122 may be positioned on the roof of the trailer. When a production unit 104 arrives at the location of the power station unit 102, that production unit 104 may be added to the system 100, which may increase total power production and energy storage capacity. Power generated by the production units 104 (e.g., trucks and trailers) may be used to power external loads, such as charging one or more electric vehicles that are connected to the system 100. For example, a consumer electric vehicle may connect to the system 100 and receive power generated and/or stored by one or more production units 104. Payment for energy received by the consumer electric vehicle may be provided to the owner or operator of the system 100 and/or to owners or operators of the connected production units 104. In some embodiments, a production unit 104 may be connected to the system 100 for a predetermined length of time. For example, a production unit 104 may be stationary for a number of hours determined by hours of service regulations. The system 100 may announce (e.g., to passing electric vehicles) that the energy production and storage capacity of that production unit 104 will be available for that expected duration.

Although only a number of exemplary embodiments have been described in detail above, those skilled in the art will readily appreciate that many modifications are possible in the exemplary embodiments without materially departing from the novel teachings and advantages. Accordingly, all such modifications are intended to be included within the scope of this disclosure as defined in the following claims.

While the methods, equipment and systems have been described in connection with specific embodiments, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used in the specification and the appended claims the singular forms “a,” “an”, and “the” include plural referents unless the context clearly dictates otherwise.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods, equipment and systems. These and other components are disclosed herein, and it is understood that when combinations, subsets, interactions, groups, etc., of these components are disclosed that while specific reference of each various individual and collective combinations and permutation of these may not be explicitly disclosed, each is specifically contemplated and described herein, for all methods, equipment and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

Further, the present method and system may also include computer-readable media for carrying or having computer-executable instructions or data structures stored thereon. Such computer-readable media can be any available media that can be accessed by a general purpose or special purpose computer. By way of example, and not limitation, such computer-readable media can comprise physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. Computer-executable instructions comprise, for example, instructions and data which cause a general purpose computer, special purpose computer, or special purpose processing device to perform a certain function or group of functions.

It should further be noted that any patents, applications and publications referred to herein are incorporated by reference in their entirety.

What is claimed is:

1. A system for zero-emission power generation, comprising:
a power station unit comprising a power controller and an alternating current power distribution system; and
a plurality of production units, wherein each production unit comprises a zero-emission power generation system and an energy storage system;
wherein the power station unit is coupled to each of the plurality of production units via a direct current connection and an alternating current connection; and
wherein the power controller of the power station unit is configured to: (i) configure a power distribution element of a first production unit of the plurality of production units to cause power generated by the power generation system of the first production unit to flow to the power station unit via the direct current connection, and (ii) configure the alternating current power distribution system of the power station unit to deliver the power generated by the power generation system of the first production unit to the plurality of production units via the alternating current connection.

2. The system of claim 1, wherein the power generation system of each production unit comprises a photovoltaic solar power generation system, wherein each production unit comprises a string of photovoltaic panels configurably coupled to the direct current connection and the energy storage system.

3. The system of claim 1, wherein the power distribution element comprises a controllable bypass switch coupled to the power generation system.

4. The system of claim 1, wherein the power controller of the power station unit is further to configure the first production unit to store the power received via the alternating current connection with the energy storage system.

5. The system of claim 4, wherein the power controller of the power station unit is further to configure the first production unit to output stored power from the energy storage system to the power station unit via the direct current connection.

6. The system of claim 1, wherein the power controller of the power station unit is further to configure the alternating current power distribution system of the power station unit to deliver the power generated by the power generation system of the first production unit to an external load via the alternating current connection.

7. The system of claim 6, wherein the external load comprises an electric vehicle charging station.

8. The system of claim 1, further comprising an external load or an internal load coupled to a production unit, the production unit to deliver the power generated by the power generation system of the first production unit to the internal load or the external load.

9. The system of claim 1, wherein each production unit comprises a portability feature.

10. The system of claim 9, wherein each production unit comprises a trailer having a plurality of wheels, a towing attachment, and a roof-mounted solar panel.

11. The system of claim 10, wherein each production unit trailer comprises an occupiable space.

12. The system of claim 9, wherein each production unit comprises an over-the-road vehicle.

13. The system of claim 9, wherein each production unit comprises a shipping container.

14. A method for zero-emission power generation, comprising:
connecting a power station unit to a plurality of production units, wherein each production unit comprises a zero-emission power generation system, and wherein the power station unit is coupled to each production unit via a direct current connection and an alternating current connection;
configuring, by a power controller of the power station unit, a power distribution element of a first production unit of the plurality of production units to cause power generated by the power generation system of the first production unit to flow to the power station unit via the direct current connection; and
configuring, by the power controller of the power station unit, an alternating current power distribution system of the power station unit to deliver the power generated by the power generation system of the first production unit to the plurality of production units via the alternating current connection.

15. The method of claim 14, wherein the power generation system of each production unit comprises a photovoltaic solar power generation system.

16. The method of claim 14, wherein each production unit comprises an energy storage system, further comprising:
configuring, by the power controller of the power station unit, the first production unit to store the power received via the alternating current connection with the energy storage system.

17. The method of claim 16, further comprising configuring, by the power control of the power station unit, the first production unit to output stored power from the energy storage system to the power station unit via the direct current connection.

18. The method of claim 14, further comprising delivering the power generated by the power generation system of the first production unit to an external load or an internal load coupled to a production unit.

19. One or more non-transitory, computer-readable media comprising a plurality of instructions that, in response to being executed, cause a power controller to:
configure a power distribution element of a first production unit of a plurality of production units to cause power generated by a zero-emission power generation system of the first production unit to flow to a power station unit via a direct current connection; and
configure an alternating current power distribution system of the power station unit to deliver the power generated by the power generation system of the first production unit to the plurality of production units via an alternating current connection, wherein the power station unit is coupled to each production unit via a direct current connection and an alternating current connection.

20. The one or more non-transitory, computer-readable media of claim 19, wherein each production unit comprises an energy storage system, further comprising a plurality of instructions that, in response to being executed, cause the power controller to:
configure the first production unit to store the power received via the alternating current connection with the energy storage system.
